(19) United States
(12) Patent Application Publication
(10) Pub. No.: US 2009/0077092 A1
(43) Pub. Date: Mar. 19, 2009

(54) Method and System for Implementing an Invention Exchange

(76) Inventor: Andrew Frederick Knight, Ewing, NJ (US)

Correspondence Address: ANDREW F. KNIGHT, 1119 TUXFORD DRIVE, BRANDON, FL, 33511, US

(21) Appl. No.: 11/857,226

(22) Filed: Sep. 18, 2007

(51) Int. Cl. G06F 17/30

(52) U.S. Cl. 707/10

(57) ABSTRACT

A method of implementing an invention exchange includes soliciting an invention disclosure of an invention, publishing the invention disclosure, selling a plurality of shares of rights to the invention to raise revenue, establishing a first threshold, determining if at least one of the revenue, number of shares sold, and total size of shares sold exceeds the first threshold, and based at least in part on the determining, causing at least one of a prior art search report to be drafted on the invention and a patent application to be drafted on the invention.

### BACKGROUND

A stated aim of the U.S. patent system is to benefit the public by enticing inventors, via offering a limited time exclusive right to their inventions, to bring these inventions to the public domain more quickly. Quid pro quo, says the Patent Office: publish an enabling disclosure of your invention in a patent document, and take an exclusive right to the claimed invention for a limited time. The system arguably worked well for the first hundred years of its existence, when most patents consisted of a few drawings and a single page of description. Unfortunately, the intricacies and complexities of a modern patent application require Joe Inventor to spend $10,000 or more on the legal fees involved with patent application drafting and prosecution alone.

While it is economically efficient for an independent inventor to invest $10,000 in an invention that would bring royalties or other income in excess of $10,000, several difficulties arise. First, the value of any invention is extremely uncertain until the invention is patented and royalties (whether through license or court order) are actually paid. Joe Inventor may have invented a $20 million idea but be unaware of its value, and therefore he may be hesitant to invest $10,000 in obtaining a patent. The value of inventions, because of their uncertainty, may be best thought of in terms of expectation. For example, if an invention has a 1% likelihood of being worth $2 million, then its expectation today is $20,000, which exceeds the $10,000 patenting cost. Nevertheless, finding the expectation of an invention is extremely difficult and unreliable, and may be costly in and of itself because experts who perform valuations of intellectual property are highly paid.

Second, individuals are often risk-averse, such that even if the expectation of an invention could be reasonably approximated at $20,000, which may exceed its $10,000 patenting cost (and thus be an efficient investment), an individual may prefer a 100% at having $10,000 than a 1% chance at having $2 million.

Third, with the mounting debt burden of the average American, many inventors, even if they would like to invest in obtaining a patent on their invention, simply do not have the resources available to so invest. For these three and other reasons, it is likely that an enormous number of inventions—some potentially very beneficial and valuable—simply never make it to the marketplace. Or, for those unpatented inventions that are successful, they are unprotected and may be stolen by anyone having more investment resources. If the goal of the U.S. patent system is to bring valuable inventions to the public domain more quickly and to reward their respective inventions for their contributions, the current system is grossly inefficient because of the high hurdles an inventor must jump to obtain protection for his idea.

This country benefits by the proliferation of new, valuable inventions.

### SUMMARY OF THE INVENTION

There is a need for a method and system for creation and implementation of an invention and patent exchange or market. The creation of this marketplace will raise capital for patenting inventions via independent investors and will more efficiently bring inventions to the public domain by enticing inventors who, for various reasons, do not have the motivation or resources to obtain patent protection on their inventions. The present invention aims to solve these and other problems.

According to one embodiment, a method of implementing an invention exchange comprises: a) soliciting an invention disclosure of an invention; b) publishing the invention disclosure; c) selling a plurality of shares of rights to the invention to raise revenue; d) establishing a first threshold; e) determining if at least one of the revenue, number of shares sold, and total size of shares sold exceeds the first threshold; and f) based at least in part on the determining in step e), causing at least one of a prior art search report to be drafted on the invention and a patent application to be drafted on the invention.

In one aspect, step f) comprises: based at least in part on the determining in step e), causing the prior art search report to be drafted, and the method further comprises: g) establishing a second threshold different than the first threshold; h) determining if at least one of the revenue, number of shares sold, and total size of shares sold exceeds the second threshold; and i) based at least in part on the determining in step h), causing the patent application to be drafted.

In one aspect, the method further comprises: causing a patent to issue on the invention; collecting profit on the patent; and distributing the profit based at least in part on the plurality of shares sold.

In one aspect, steps a)-c) are performed automatically on a website. In one aspect, the method further comprises determining a price for at least one of the shares based at least in part on at least one of the number of shares sold and the total size of shares sold. In one aspect, the method further comprises determining a price for at least one of the shares based at least in part on a time elapsed. In one aspect, step c) comprises selling the plurality of shares by auction. In one aspect, the method further comprises: receiving from a bidder a price-per-portion bid and a desired investment amount; and determining a clearing price of the auction based at least in part on the price-per-portion bid and the desired investment amount.

In one aspect, the method further comprises causing share size to automatically decrease with increase in clearing price. In one aspect, the method further comprises providing a secondary market through which investors who own the shares may sell the shares to others. In one aspect, the method further comprises providing an option for a user to publish prior art regarding the invention. In one aspect, the method further comprises requiring an inventor of the invention to retain a predetermined interest in the invention. In one aspect, the method further comprises: publishing at least one of the prior art search report and the patent application; and offering to purchase at least some of the shares sold in step c).

According to one embodiment, a method of implementing an invention exchange comprises: a) soliciting, via a website, invention disclosures of inventions; b) publishing the invention disclosures via the website; c) selling via the website a plurality of shares of rights to a first invention to raise revenue; d) establishing a first threshold; e) determining if at least one of the revenue, number of shares sold, and total size of shares sold exceeds the first threshold; f) based at least in part on the determining in step e), causing a prior art search report to be drafted on the first invention; g) establishing a second threshold different than the first threshold; h) determining if at least one of the revenue, number of shares sold, and total size of shares sold exceeds the second threshold; and i) based at least in part on the determining in step h), causing a patent application to be drafted on the first invention.

In one aspect, step c) comprises selling the plurality of shares by auction. In one aspect, the method further comprises: publishing at least one of the prior art search report and the patent application; and offering to purchase at least some of the shares sold in step c).

In one aspect, the method further comprises: causing a patent to issue on the invention; collecting profit on the patent; and distributing the profit based at least in part on the plurality of shares sold. In one aspect, the method further comprises: providing users a preference indicator with which to express preference for an invention; and publishing a preference indicator rating of the inventions based on preference indications by the users.

### BRIEF DESCRIPTION OF THE DRAWINGS

FIG. 1 shows a first web page according to an embodiment of the present invention.

FIG. 2 shows a second web page according to an embodiment of the present invention.

FIG. 3 shows a third web page according to an embodiment of the present invention.

FIG. 4 shows a fourth web page according to an embodiment of the present invention.

### DETAILED DESCRIPTION

The disclosures of U.S. Pat. Nos. 5,950,176 and 6,505,174 to Keiser et al., and U.S. Patent Applications Nos. 20070174341 to Saripalli, 20070088645 to Lin, 20060155572 to Postrel, 20030101073 to Vock, and 20010032144 to Magid are hereby incorporated by reference to the degree necessary to enable one of ordinary skill in the art to make and use the present invention.

According to an embodiment of the present invention, an inventor may raise revenue or capital with which to pursue a patent on his invention by selling shares in his invention to investors. For example, he may sell discrete portions of rights to his invention, such as 1% shares (although they could be larger or smaller in size), at predetermined prices (which may be fixed or may change depending on time, sale history, value of the invention, and so forth) or at prices determined in other manners (such as through an auction), so as to raise sufficient revenue to obtain a patent on the invention. Because obtaining a patent requires a certain minimum amount of money (e.g., government fees), the present method may utilize at least one threshold whereby a patent is pursued if and only if the threshold is reached through the selling of shares or raising of revenue. The threshold may be in units of revenue raised, number of shares sold, total size of shares sold, or any other threshold. For example, if the threshold is 100 shares sold (e.g., at a predetermined size, such as 0.3%), then if the inventor, through a company implementing the present invention, sells 100 shares of his invention, then the threshold is reached and a patent is pursued. If the threshold is 30% (e.g., having a predetermined minimum value), then if the inventor sells 30% of his invention, then the threshold is reached and a patent is pursued. If the threshold is $10,000 (e.g., sold in a predetermined number of shares each having a predetermined size), then if the inventor sells $10,000 worth of his invention, then the threshold is reached and a patent is pursued.

If the threshold is not reached, then the revenue raised (if any) may be refunded in whole or in part to the investors, possibly minus any fees or administrative costs to the company implementing the present invention (hereafter “the company”).

Throughout the present application, several examples will be given that suggest that share sizes, share prices, numbers of shares for sale, and so forth may be predetermined—however, these examples are only for the sake of example and any values that may be predetermined may alternatively not be predetermined. For example, if a threshold is $10,000 for pursuing a patent, then this may be raised by selling 1000 shares of 0.2% share size for a price of $10/each. However, any of these values may vary and need not be predetermined. For example, the price per share may be determined by an auction, in which case the price is not predetermined. As another example, the price per share may be held constant, and an auction may determine the share size that is purchased by the share price (i.e., instead of the price per share increasing, the share per price would decrease), in which case the share size is not predetermined. As another example, the number of shares sold (or the total share size) may vary, in which case these are not predetermined values.

The present invention may utilize one or more thresholds for raising the required revenue. For example, an invention in the raw is very different in value or expectation from an invention for which prior art has been searched, which is different in value from an invention for which a patent application has been drafted, which is different in value from a patented invention. A first threshold may, for example, be a revenue corresponding to a cost of submitting a provisional patent application to the U.S. Patent and Trademark Office, which may or may not include fees for additional services or administrative or handling or legal services fees. For example, if the first threshold is $150, which may correspond to the price for a registered patent agent to submit an inventor's invention as a provisional patent application, then the inventor may, for example, sell 15 shares of his invention (each share corresponding to some portion of his invention, such as 0.1%) for $10/each. Once the revenue raised meets or exceeds the threshold, the invention (and its disclosure) are then submitted to the Patent Office in the form of a provisional application. Alternatively or in addition, the first threshold may correspond to a number of shares sold (such as 15) or a total size of shares sold (such as 1.5% of the invention).

The first threshold may alternatively correspond to the price for a professional prior art search to be performed, which may or may not include fees for additional services or administrative or handling or legal services fees. For example, if a search report for an invention costs $400, then the first threshold may be reached when the revenue raised from selling shares of the invention meets or exceeds $400, such as by selling 40 shares of 0.1% at $10 each. Of course, the share size, price, thresholds, and so forth, may vary according to the desires of the user of the present invention. Further, the first threshold may include the cost necessary for a variety of services, such as:
Contacting the inventor to obtain details on conception (e.g., date, how it was conceived, what work has been done on it, etc.), any reduction to practice or attempts to build or use, publications and offers for sale and public uses (and dates), known prior art, inventorship (and whether inventors are over age 18), obligations to assign the invention elsewhere, etc.
Obtaining the inventor's or inventors' signature on the contract
Drafting a better or fuller description based on the inventor's description
Filing the fuller description as a provisional patent application
Performing a prior art search based on the fuller description and ultimately publishing the search report
Other services related to or preliminary to the drafting of a full patent application

For example, the cost of the above services may be $1000, and the first threshold may be $1000. This threshold may be reached by selling, for example, 10 shares at $100 each, 100 shares at $10 each, and so forth, where shares could range in portions of the invention from 0.01% to 1% or more.

If more than the first threshold is raised, then the additional money may be placed in an escrow account, such as an interest-bearing escrow account, to be used toward the invention (such as in meeting a second threshold, drafting a nonprovisional utility patent application, etc.). (Revenue raised before reaching thresholds may also be held in an interest-bearing escrow account, to be used toward paying for services after reaching the corresponding threshold, or refunded to investors according to procedure discussed later if the corresponding threshold is not reached.) Alternatively or in addition, after the prior art search report is published, investors (i.e., purchasers of the inventions' shares) may be offered the chance for a partial or full refund. For example, if those initial 100 shares (e.g., at 0.1% portion each) are sold for $15/each, thus raising $1500, then after $1000 is spent on the above services, the remaining $500 may be spent on the invention at a later time, or some or all may be used in providing refunds. For example, after the search report is published, investors may have the option of requesting a refund. If a small number, such as 10, request a refund, they may then be able to sell back their shares and get a full refund, thus reducing the excess by $150. However, if too many people request refunds, then only the remaining $500 may be used to divide up among those requesting refunds. For example, if 50 people request refunds, then each receives only $10 in return, and if all investors request refunds (such as if the search report identifies very strong prior art), then $500 is divided among 100 shares, resulting in a $5 per share refund. In one embodiment, no shareholder may receive a refund larger than his investment. In another embodiment, no shareholder may receive a refund larger than his investment unless interest or other gains accrued on the invested amounts exceed administrative costs and the company decides to distribute these amounts back to the investors requesting refunds.

Of course, refunds may be issued even before all of the money involved with the first threshold is spent. For example, if after contacting the inventor (and before a prior art search is requested), it is clear that the inventor stole the idea from another, or had an obligation to assign the invention to an employer, or published the idea more than a year ago (or any other one of a series of “deal killers”), then after a small administrative fee, the remaining amount invested may be refunded to all investors on a pro-rata basis. Further, if an invention never reaches the first threshold in the required period of time (such as a week in the case of a one-week auction or two weeks in the case of a two-week auction, etc.), then any money invested may be refunded to the investors (minus any administrative costs).

Once the search report has been written and published, the expectation or value of the invention may be significantly different. For example, if the search report identifies a patent or publication that completely discloses the described invention, then the invention may have little or no value, in which case several or all of the investors may request a refund (which may only be a partial refund). As discussed, these investors may only be eligible for a partial refund if, after paying for sunk costs (e.g., the prior art search report and administrative costs), there are insufficient funds to provide full refunds to those investors requesting refunds. However, if a professional search report fails to uncover a patent or publication that would prevent the invention from being patented, then the invention's expected value may be far greater than before the search was performed. Under such circumstances, the market value of the invention may be sufficient to justify the drafting of a nonprovisional patent application and the obtaining of a patent, which may be relatively expensive.

If the first threshold is not reached, then refunds (or at least partial refunds after paying any fees or administrative costs) may be given or at least offered to investors. In the case of an auction, the method of the present invention may be such as to not debit any investors' accounts or credit cards if the required number of shares is not sold, or if they have been debited, giving or at least offering a full or partial refund of the amounts bid. For example, in the case of selling shares individually for a predetermined price, or a price that depends on other factors, the users' accounts may simply not be debited until after enough funds have been committed to reach the first threshold, or if they have, then refunding or at least offering to refund at least part of these amounts after any costs or administrative fees are paid. For example, assume that enough shares have been sold (at the same or differing prices) to raise only $600. At some point, such as after a week or two, the sale may end and it is determined that insufficient revenue has been raised. Perhaps a $50 administrative or handling fee is removed from this revenue, and the remaining $550 is refunded to the investors, either equally per share or commensurate with the price paid for each share. If an auction is performed, and 100 shares at a starting bid of $10 each must be raised to reach the first threshold, and if only 60 shares are bid for, then either the investors' accounts are not debited at all, or if they are, doing something similar as stated above (e.g., refunding or at least offering to refund completely or after a fee is removed). By offering refunds, of course the investors are giving up their shares in the invention. In other words, offering refunds may imply that the company offers to purchase shares back from the investors at the same or a reduced price as the investors paid.

In one embodiment, a company implements at least part of the method of the present invention on a website. Websites are well understood in the art, and most basically comprise software executed on computers or servers that are connected to the Internet so as to be assessable by people around the world. Because it is important to pursue a patent application as quickly as possible, an invention should probably not remain published (e.g., on a website) for an excessively long time without diligence on the inventor's part to reduce the invention to practice (either by building or submitting a patent application). Thus, one means of raising revenue to exceed the first threshold is selling a certain number of shares in an auction at a certain starting bid, and ending the auction at a certain time (not a necessity if shares are sold one-by-one), such as in one week. In one embodiment, if the required number of shares are not bid on by the auction end, the auction may be considered failed, and a second auction (e.g., lasting a week) may be performed immediately thereafter. This process may repeat a few times, but at some point the invention may be abandoned by the company unless the inventor immediately submits the invention disclosure in a provisional patent application (via the company), thus protecting the idea for a limited time while the invention continues to seek funding via selling shares. For example, if the first threshold is not reached within a predetermined time (e.g., insufficient shares are sold in an auction or insufficient revenue is raised in selling shares), then the inventor may be required to pay the company to submit a provisional patent application (currently $100 at the Patent Office, possibly plus an administrative or handling fee by the company) in order to allow the invention to remain published and for sale through the company. Without such a step, there is the concern that another inventor could independently invent the invention in the intervening time and apply for a patent, and that the first inventor could lose rights to it for failing to be “diligent” in pursuing patent protection. However, once a provisional patent application is on file, the inventor might be allowed to continue trying to raise revenue or sell sufficient shares to reach the first (or second or “search”) threshold, for a predetermined amount of time or number of auctions. However, there is a limit: U.S. Patent Law does not allow pursuit of a patent on an invention that has been published more than 1 year before a patent application filing date, and a provisional patent application lasts only 1 year. If the inventor then fails to submit a provisional patent application (preferably paying the company to do so) before a predetermined amount of time or number of auctions, then the company may remove the invention from publication or the website and stop attempting to sell shares in the invention.

Alternatively or in addition, an inventor may opt to pay for submission of a provisional patent application (preferably through the company) before the submitted invention is published on the website. For example, the inventor could be given the option of simply posting or publishing his invention on the website to raise revenue in part to submit a provisional patent application, or may opt to independently pay for submitting the invention disclosure as a provisional patent application before the disclosure is published for sale on the website and available for raising revenue for reaching the search threshold, patent threshold, etc.

Alternatively or in addition, the inventor could opt to use the company's website or services only to reach a particular threshold. For example, assume that an inventor has sufficient funds to pursue a patent application on his invention, but desires to use the website to determine market interest in the invention. He could, for example, sell enough shares only to reach the first threshold (or the threshold corresponding to the prior art search report), at which he then independently pays for the remainder of the patent prosecution process (e.g., patent application drafting, submission, prosecution, issuance, etc.). He benefits by learning that sufficient interest exists in his invention to justify spending more of his own money on the invention. In this embodiment, it is preferable that the inventor place a certain amount of money (e.g., $10,000 if he intends to avoid the final or patent threshold) in escrow (preferably through the company) that ensures the initial investors that a patent will be pursued if the threshold (chosen by the inventor) is reached. As a different example, he may be willing to pay for submitting a provisional patent application and for all the services performed on reaching the next threshold (such as a prior art search report, etc.) by himself, and then rely on the website only for reaching the final or patent threshold. In other words, an inventor might be able to front enough money for some of the services and fees required for obtaining a patent, but use the website to generate the remainder of the money necessary. Alternatively or in addition, the inventor with sufficient resources may use the website only to gauge market interest, such as publishing the invention on the website and measuring a preference indicator rating (e.g., a number of stars or preference indicators submitted by users, as discussed later) of his invention.

A second threshold (or third threshold, if the first threshold corresponds to the filing of a provisional patent application and the second corresponds to obtaining a prior art search report and/or other services) may correspond to the cost of drafting a patent application, obtaining a patent, and so forth. For example, if the cost of having a patent application drafted is $5000, then 250 shares of 0.1% each may be sold at $20 each. The price per share or per percent may be greater (or different) than prior to the search report being drafted, because of the new information that the search report reveals. Alternatively, the second threshold may include the cost necessary for a variety of services, such as:
Drafting a nonprovisional patent application
Prosecuting the nonprovisional patent application
Government fees for application, publication (such as early publication), issue, and maintenance for a predetermined number of years

For example, if the total cost of these is expected to be approximately $10,000, the second threshold may be $10,000 and may be reached when the revenue raised from selling shares of the invention meet or exceed $10,000. If so, then a portion of this revenue may be immediately spent on legal, administrative, and government fees for drafting and submitting a nonprovisional patent application. The remaining portion may be held in an interest-bearing escrow account for use later. For example, the Patent Office often does not reply to patent applications for at least 14 months, although often exceeding 3 years. At this point, the money in the escrow account may be used for the legal and administrative and government costs of prosecuting the patent application, if possible, to issuance. Of course, it is impossible to know apriori how much it will cost to draft a patent application and prosecute it to issuance. However, most patent applications can be drafted by competent patent agents or attorneys in the neighborhood of $5000, and most patent applications will require two or three responses to Patent Office actions before the Patent Office agrees to allow the invention. Again, costs vary widely depending on the invention, the scope of the Office Action, and the price and skills of the prosecuting agent, but one may estimate the fees to respond to two Office Actions at around $2400. Government fees for application, publication, issuance, and maintenance are generally fixed. The costs for prosecution, issuance, and maintenance may be paid for using the funds in the invention's escrow account. Of course, the company's thresholds may be adjustable depending on inflation, attorney or patent agent costs, government fees, and so forth.

In the case of a Dutch auction (i.e., multi-unit English ascending auction) where the starting bid is set at a level such that, if all shares are sold, then the second threshold is necessarily reached, then there is no problem if all shares are sold. However, if only some or no shares are bid on, then the auction may be set up such that no shares are actually sold at all (e.g., no investors' accounts are debited or no credit cards charged), or if the shares are sold, then they may be refunded (less any administrative or legal or handling fees) after the auction is over. Alternatively or in addition, if the second threshold is not reached, but money has already been collected for selling some shares, then the excess raised funds may be distributed evenly among (or commensurate with) all shares sold, possibly including those sold to meet the first threshold, minus any administrative or legal or handling fees. Of course, any of the features or methods discussed with respect to the first threshold may apply to reaching (or not reaching) any following thresholds.

In the case where excess funds beyond the second threshold (or beyond what is needed to reach the second threshold, including excess revenue from exceeding the first threshold) are raised, these funds may remain in an escrow account for use for any expenses over and above what is covered by reaching the second threshold. For example, some patent applications are more costly to draft and prosecute than others, or require more claims (which cost more money), in which case having additional funds available is beneficial. Or, these excess funds (or at least part of them) may be given to the inventor (because it was the inventor's share in the invention that was ultimately being sold to raise sufficient revenue to patent the invention) and/or the company (who brokers the transaction and provides the inventor the medium and opportunity to sell his idea), and/or the investors (although the investors are, in principle, paying market value for their shares, so distributing a non-profit excess to them might be economically inefficient). For those funds that are paid to the inventor, they may be held in escrow for a predetermined amount of time or at least until certain events occur. (These funds may be used at least in part for a sort of emergency or contingency fund to be used by the company for unexpected or excessive legal or government fees related to obtaining or maintaining the enforceability of a patent. Such a fund is discussed later.) For example, an inventor who fraudulently steals another's invention, and is able to through the present method to reach both thresholds and attain an excess, should not be able to enjoy that excess. However, it is often difficult to know whether a patent will hold up in court, or will be declared invalid or unenforceable due to inventor fraud, until far in the future, and often only when an expensive, high-powered attorney team fighting the patent in litigation discovers this information. By then, if the inventor is paid along the way, these excesses may have already been spent and enjoyed by the faux inventor. To prevent this (or at least reduce the likelihood of this), and thus to encourage investor confidence in the marketplace herein proposed, the excess funds raised, as well as any excess funds raised by the inventor selling her shares (up to a maximum allowed share size), may be kept in escrow (such as interest-bearing accounts, real estate, stocks, bonds, or other assets that grow with time) for a predetermined time, such as 1 year, 3 years, 5 years, or a predetermined event, such as a patent issuing, a significant license agreement entered into, a patent infringement litigation outcome, and so forth.

The present invention may utilize one or more thresholds. For example, a single all-or-nothing threshold may be used (e.g., set at around $10,000 or more), such that those inventions that reach the single threshold have patent applications drafted and submitted. The single threshold may include some, all, or other services than those previously mentioned. A lower threshold (such as $3000) may allow a very inexpensive patent application to be drafted and submitted, with no prior art search, and no funds available for prosecution or issuance. However, the inventor may be contractually obligated to pay for such fees and services, or the funds may come from other sources, when the time for these fees arises. An advantage to such a scenario is that fewer funds need be raised to begin the process of patenting inventions. However, investors may be less likely to invest in inventions that have not been professionally searched or for which a patent application is drafted by a “budget” patent attorney, or for an invention that is patent pending but for which no funds are available to prosecute to issuance.

One possible manifestation of the present invention could use three thresholds: one for submitting a provisional patent application, a second for searching prior art to the invention (and/or other related services), and a third for obtaining a patent, although a user of the present invention may utilize only one or two of these thresholds, or may combine some of the services suggested for reaching one threshold with meeting another threshold (such as contacting the inventor and getting further information after reaching the first threshold instead of the second, etc.). Further, more than three thresholds could be established, with the meeting of each threshold corresponding to a certain set of services performed, and corresponding to a certain amount of revenue raised. (Again, the threshold may be a revenue raised, number of shares sold, a total size of shares sold, or any other threshold desired.) The inventor could opt to meet one or more of these thresholds on his own, such as the first two, and rely on the website only for reaching the final (and most costly or difficult) threshold. Or he may opt to meet the final threshold on his own if the first two are met, because this gives him valuable information as to the market value of his invention, and so forth.

Selling of shares of the invention may begin when an inventor has paid a submission fee for publication through the company, when an inventor has submitted his own funds for investment (and, for example, desires to skip over one or more of the thresholds, such as the threshold corresponding to the prior art search report), or when the inventor or the company deems sufficient market interest from a predetermined amount of preference indicators (such as “stars” that users may assign to their favorite inventions). Selling of shares of the invention may end when all thresholds have been reached, or when enough money is raised (by investors and/or by direct payment from the inventor) to be able to obtain a patent on the invention (with enough money to maintain the patent for a predetermined period of time), when enough money is raised as deemed by the inventor to determine sufficient market interest for independent investment by the inventor himself for the remaining amount necessary to reach the final threshold, or when auctions have finished and succeeded. For example, after reaching the second threshold above, selling of the shares by the company or inventor may end. Alternatively, the inventor may opt to sell additional shares in the invention for her own benefit, to obtain a monetary benefit up front. The following is one example of one possibility according to the present invention.

Herein, the phrases “first threshold,” “second threshold,” etc., are used to generically demarcate thresholds at which various services may be performed. Alternatively or in addition, thresholds could be known as a provisional threshold (at which a provisional patent application is submitted), search threshold (at which a prior art search and/or other services are performed), and a patent or nonprovisional threshold (at which a nonprovisional patent application is drafted and filed and/or other services are performed). There could be other thresholds, such as an issuance threshold, maintenance threshold, and so forth.

The following will describe one possible example of an implementation of the present invention, although any variations obvious to one of ordinary skill in the art are within the scope of the invention.

Shares in an invention may be sold by any known method, but may include a Dutch auction. In such a Dutch auction, many shares are sold at the same time, in an auction lasting a predetermined period of time, and investors can make bids on a desired number of shares. As an example of an auction selling 3 shares at a minimum price of $0.50, assume that a first investor bids $1 and a second bidder bids $2, and the auction ends. The clearing price (or the price at which all shares bid on will sell) remains at $0.50. The auction may be designed such that exactly two of the three shares sell at $0.50 each, or may be designed such that all shares must be sold or none of them are sold. (The latter design may be more useful in the present invention, since a threshold must be reached before an invention is acted upon.) If instead (i.e., before the auction ends) a third investor bids $3, then the clearing price may increase to the minimum bid of the existing bidders, which is $1. If the auction ends with no further bidding, then all shares will sell at the clearing price. If instead (i.e., before the auction ends) a fourth investor bids $4, then the clearing price jumps up to the minimum bid of the top three (because three shares are for sale) bidders, which is $2. This process continues until the auction ends, and then all shares sell for the clearing price. Of course, the present invention includes any known auction method or method of determining prices, and is not limited to Dutch auctions, fixed prices, or prices that change according to a predetermined algorithm. For the sake of explanation, most examples herein will use a version of the above-explained Dutch auction for determining prices of invention shares for sale, although this is not meant as a limitation.

Assume for the present example that if the first threshold is $1000, then 100 shares of 0.1% of an invention (prior to search) are sold in an auction, such as a Dutch auction. The starting bid for these shares is $10 each (for a total of 10% to be sold), guaranteeing sufficient revenue to perform a prior art search and other services preliminary to drafting a patent application if, indeed, enough investors are found. The auction, which might last for any period of time, such as a week, ends at a clearing price of $12.50, such that the revenue collected is $1250.

Next, the company implementing the present invention begins to perform various services, such as contacting the inventor and obtaining information, preparing a fuller description of the invention for search purposes, hiring a professional searcher to search the invention, filing a provisional patent application, etc., whereby the total cost is, say, $1000. (It is assumed that the invention is not abandoned before the search stage due to inventorship, ownership, or other problems.) This leaves a $250 excess that is placed in escrow.

Next, the search report is published on the website next to the invention posting, and investors are given the opportunity to request a refund (such as within a specified period of time). Of course, if the search report does not yield results that are likely to prevent a patent from being obtained, then few investors are likely to request refunds, and vice versa. Assume that 10 people request refunds. Because there is sufficient excess to provide full refunds, all are given full refunds. (If there is not enough excess, the remaining excess is divided evenly among or commensurate with all those requesting refunds.) Thus $125 is refunded, leaving another $125 remaining in escrow. Next, if the second threshold is $10,000, then 250 shares of 0.1% could be sold in an auction, such as a Dutch auction, with a minimum or starting price of $40 per share (for a total of 25% sold). Of course, many different variations are within the scope of the present invention, such as selling 1000 shares of 0.02% at a starting price of $10 per share (for a total of 20% sold), or 400 shares of 0.1% sold with a starting price of $25 per share (for a total of 40% sold), and so forth. Alternatively or in addition, the second threshold may be reduced by the excess revenue already raised, such as $125 in this example, so that $9875 needs to be raised by selling 1000 shares of 0.02% each, with a starting price of $9.875 each, and so forth. Assume the auction of 1000 shares of 0.02% each, which might last for any period of time, such as a week, ends at a clearing price of $21.30, such that the revenue collected is $21,300. Adding to the previous escrow amount, the total in escrow is $21,425, of which only $10,000 is needed to pursue a patent. (A different number may be chosen, depending on the invention, to be higher or lower than $10,000. This number could be chosen based on advice from a patent agent/attorney or other professional, complexity or field of the invention, or other factors, and may even be determined after a patent application is drafted. For example, if an invention is sufficiently complex that a patent application costs $7000 to draft, then an estimate for submitting and prosecuting this application may be generated based on this higher application cost, and more than $10,000 total may be set aside and ultimately used to patent the invention, and vice versa for an invention that may be particularly simple and inexpensive to pursue a patent.) Assuming that $10,000 is selected as the money necessary to obtain a patent (and possibly maintain that patent for a predetermined period of time), then the excess is $11,425, and may either remain in the escrow account or may be distributed to one or both of the inventor and the company. What remains in the escrow account may then be used to pay administrative, legal, government, and other fees for drafting, submitting, prosecuting, issuing, and maintaining a patent application to issuance. In this example, the $11,425 is then given to the inventor, or as previously discussed, may be given to the inventor in whole or in part after a certain period of time or after certain events have come to pass, in order to prevent or limit unjust enrichment to a false or dishonest inventor.

In this example, 10% of the invention was sold to raise revenue for the first stage to meet the first threshold, and another 20% was sold to raise revenue for the second stage to meet the second threshold. Another 5% or 10% is retained by the company (for administrative, legal, processing, or other fees, and/or profit), and the remainder of the interest goes to the inventor. Of course, these numbers may be substantially modified. For example, it may require selling substantially more than 30% of an invention to raise sufficient revenue to patent the invention. However, in one embodiment, the inventor is contractually required to retain a substantial interest (such as at least 10%, preferably at least 25%, preferably at least 40% and more preferably at least 50%) in his invention, so that he is motivated to cooperate in finding licensors and infringers, participates in litigation (if necessary), and ultimately maintains a substantial share in that which he invented. After all, if an invention is successful, it benefits the public to reward the inventor commensurate with his contribution to society.

If sufficient revenue has been raised to patent an invention by selling less than the maximum size of shares allowed to be sold, the inventor may be given the option of selling these remaining shares. In the above example, the company keeps 10% of the invention, 30% of the invention has been sold to raise revenue to patent the invention, leaving 60% for the inventor. Assume that the inventor is contractually required to retain at least a 40% share in her invention. She may then sell (such as through an auction) the remaining 20% of the invention, possibly at any point in time, and the company may broker this transaction. For example, after the patent application has received a first Office Action from the Patent Office, which indicates that several claims in the patent application are being allowed (and which information is accessible by the general public on published patent applications through the official Patent Office website, and/or which may be published by the company, such as on a website, adjacent to the invention posting), the value of the invention may increase, and the inventor may at this time wish to sell by Dutch auction 10% of her invention by auctioning 100 shares of 0.1% or 1000 shares of 0.01% each, with a minimum or starting bid of $10 or $100 or a price that is determined by the company. She may then wait until the patent actually issues to sell another 10% of the invention in her own chosen or predetermined share portions or sizes. She may decide not to sell any more of the invention than is necessary to get a patent, or she may sell all but her contractually required interest, or any quantity in between.

The revenue she obtains by selling additional shares in her invention (and/or excess revenue raised by trying to meet the final threshold that allowed a patent to be sought on the invention, such as $11,425 in the above example) may be paid directly to the inventor (possibly after a certain time period or event), and/or an administrative fee in the form of a flat fee or percentage may be charged for these transactions by the company. The company, of course, may sell its shares in an invention, but preferably retains these shares because the profit according to the business model of the present invention comes not only from administrative and other user fees, but also from royalties from valuable inventions discovered through use of the company's invention brokering services.

The following will describe one possible example of an implementation of the present invention, although any variations obvious to one of ordinary skill in the art are within the scope of the invention.

The present invention may be implemented by a company through a website (although any media application is within the scope of the present invention), such as www.usipe.com, which may be the URL of a company named the U.S. Invention & Patent Exchange, whose acronym may be USIPE. An inventor may go to the website, which solicits and encourages him to submit an invention disclosure, such as by providing a “Submit Invention” link (described later), or by indicating to the inventor a capability of submitting his invention to the website, getting the invention patented through independent investment, and ultimately profiting from the invention, such as though a “How It Works” link (described later). Other ways of soliciting an invention disclosure of an invention from an inventor will be understood by those of ordinary skill in the art and are within the scope of the present invention. At this website, he can create a user account and submit an invention profile or submission, including at least some of the following elements: abstract (such as a short description), detailed or full description, diagrams, images, figures, drawings, photographs (e.g., of actual prototypes), video (e.g., of the inventor discussing the invention or showing a prototype in operation), a description of her conception of the invention, inventorship information (e.g., who are the inventors and of what aspects), contact information, ownership information (e.g., whether the inventor has an obligation to assign the invention to another, such as an employer, or if the inventor has already promised some share of the invention to another), whether the invention has been in public use or on sale or has been described in a publication or patent in the past year, the stage of development of the invention (and whether a patent application has been written or submitted or whether a patent currently exists), what is known about the field and what prior art exists, why the invention is valuable, the invention category, and so forth, including any information that may be useful to the company in determining whether to allow publication of such an invention on the website and to investors in determining the value of the invention. The inventor then must agree to a contract, which may include any of the following elements: that all disclosures about the invention are true to the best of her knowledge and that she agrees to be personally liable for any fraud or intentional misrepresentations, that she assigns all rights and interests in the invention to the company in exchange for royalty rights consistent with the share sale schedule, that she agrees to cooperate in development and prosecution of the invention and in litigation and/or licensing of the invention, that she agrees to the company's method (e.g., attempting to auction a predetermined number of shares at a predetermined starting bid to reach a first threshold, but, if one or a predetermined number more of these auctions fail, requiring the inventor to pay for submitting a provisional patent application or else removing the inventor's invention from the website, attempting to auction a predetermined number of shares at a predetermined starting bid to reach a second threshold, etc.), that she agrees to pay a listing fee (such as $5 or $10 per invention or a set price per inventor), that she agrees to retain a predetermined share in her invention (such as at least 40%) and will not sell or transfer that share to anyone except in case of death or as ordered by a court of law, that she agrees not to compete with the company such as by patenting slight variations on the invention, and any other terms that are fair to the inventor but will also encourage confidence in investors.

The inventor then pays the required submission fee and the invention is available for sale of shares. The submission fee may be paid a single time for an invention, which is given one or more “tries” to reach one or more thresholds before being removed from sale from the website, or may be paid each time such a try fails. For example, if a predetermined share size is to be sold via a one-week Dutch auction after the inventor submits his invention and pays the submission fee, and if the auction fails (according to the terms of the contract between the inventor and the company, such as if the threshold is not met during that week), then the inventor may be required to resubmit the invention and/or pay another submission fee or other fee to allow the invention another chance at reaching one or more thresholds. This may occur for a predetermined number of submissions, such as up to three, before the company then requires the invention to be removed from the website permanently (or else requires the inventor to pay for a provisional patent application to be filed on the invention disclosure).

Shares may be sold one-by-one at a predetermined set or changing price (such as an increasing price (such as exponentially) and/or a price that decays (such as exponentially) with time), perhaps for a predetermined period of time (such as one week, two weeks, or one month), until either the first threshold is reached or until the sale fails. If the sale fails, it may be repeated, but not indefinitely, until the inventor is required to pay for the invention disclosure to be submitted as a provisional patent application or the invention is removed from sale from the website. If the sale succeeds, then the invention moves from a first phase to a second phase, in which more shares are sold until the second threshold is reached. Again, in both cases, shares may be sold one-by-one at a predetermined set or changing price, or shares may be sold through auction, or any other known method for selling shares. Auctions are more likely to bring a price that is closer to fair market value. Shares may be sold one at a time through an auction, but this may be very time consuming and inefficient if many shares are to be sold. To keep the price of shares sold at a reasonable price accessible by most members of the public (to allow the public as a whole to be investors), such as $10-$50 per share, too many shares will have to be sold to justify a single auction at a time, in which case a Dutch auction will be very useful.

If the first threshold is not reached, and the inventor is not allowed to continue selling shares (such as because time has expired in terms of requirements under U.S. patent law regarding publication or provisional patent applications, or because of other requirements of the company), any funds or revenue raised may be returned to the investors after payment of administrative or handling fees, if any, and the same may be true of failing to reach the second threshold or any following thresholds. Any of the methods described herein of refunding fully or partially the investors may be implemented. In one aspect, the inventor is given the opportunity to pay a fee to extend the length of time available to reach one or more thresholds. For example, in a one-week auction which, at the end of the auction, is near but has not reached the required threshold, the inventor may be given the opportunity to extend the auction by one or more days through payment of a fee.

Such a feature may discourage investors from investing, however, because the “end” of the auction, in this case, would not truly spell closure to their gamble. Alternatively or in addition, the inventor may be given the opportunity to pay the remainder necessary to reach the threshold before the auction is officially declared closed or failed. For example, in a one-week auction in which, at the close of the auction, 90 of a required 100 shares of 0.1% are bid on at $10/each, the inventor may have the option (within a specified time period, such as 24 hours) to bid on the remaining 10 shares necessary to reach the threshold.

Further, in one embodiment, the inventor must assign all rights to the company, because inventors may be too emotionally attached to their inventions or deluded by profit potential to make economically sound decisions regarding them. Potential investors will be more likely to invest if they are confident that license and litigation decisions will be made by a more objective body whose goal is to maximize profits for the shareholders. Further, potential licensors and other interested parties will be able to go to an easily identifiable source—such as the company—when attempting to use or license an invention, which is economically efficient. By assigning all rights to the company, the inventor loses decision-making power with regard to the invention, but not royalty rights, as he will be retaining all shares not sold to raise revenue to reach the necessary threshold(s) and paid to the company as a commission (such as 5% or 10%). For example, in the example previously given, the inventor retains 60% of the economic value in his invention, so that he is entitled to 60% of royalties or court settlements, etc., arising from the patented invention. While the company may own the invention outright, it still makes contractual agreements with the shareholders and inventor to pay portions of royalties received, and it only keeps its allotted share (such as 5% or 10%). Alternatively, the inventor may retain all rights to the invention, except those shares sold, and may be required to keep at least a controlling interest in the invention. While this is not as preferred as a third party or company owning the controlling interest in the invention, it is better than selling off small shares to lots of shareholders and no single person or entity having a controlling share—in such a case, it may be difficult to make any decisions regarding the invention.

One advantage to charging a listing fee for listing inventions, particularly a nominal fee, is that it not only helps defray certain administrative and operational costs by the company before one of the company's brokered inventions hits “big” and pays the company a substantial royalty, but it also provides a minimum threshold of usefulness and value of inventions listed. While the current barrier to entry for Joe Inventor (on the order of $10,000 for a patent) is too high and excludes too many potentially valuable inventions, an inventor who is unwilling to spend $10 or $20 to list an invention is unlikely to be harboring an invention of any real value. While many completely valueless inventions will no doubt be listed on the proposed website, even with a listing fee, the number is likely to be far fewer than without any listing fee, thus requiring the public and potential investors to wade through less twaddle before finding the true invention gems.

Of course, as the market permits, additional fees and costs could be charged, such as a membership fee, transaction fees, and so forth. However, in its simplest, the inventor need only be charged a listing fee and a share of the invention. Thus, the cost to the inventor of a valuable invention is the listing or submission fee, if any, and the required commission or share paid to the company, such as 5% or 10%, which is taken from royalties, settlements, or damages ultimately collected with respect to the patented invention. However, since the present invention targets inventions that were unlikely to be patented by ordinary means (e.g., the inventor investing huge sums in patenting), the royalties collected by the patent are effectively “free” to the inventor, and thus his only real cost or risk is the listing fee. The inventor benefits by being able to obtain a patent and to keep a substantial share of the royalty rights to the patent, on an invention in which he needed invest virtually no money. In other words, the inventor need merely conceive of a great invention—the very epitome of the job of the true inventor—and let others invest in obtaining a patent, while retaining a very substantial financial interest in that invention. The inventor benefits by obtaining the potential to make a fortune on a great idea with virtually no investment of his own. His alternatives are to invest a huge sum to obtain a patent, to market and license the invention, and to sue a company if necessary, or else to simply abandon the idea.

The use of one or more thresholds may not be necessary for certain inventions. For example, if an inventor wishes to sell shares in a pre-existing patent, she may list or post the invention on the website for a certain fee (which may be different than the usual fee for submitting unpatented ideas), and sell shares through the mechanisms available (such as at a predetermined set or increasing or changing price, or an auction, or any other method known in the art for determining price). Further, if an invention has already been professionally searched but not patented, only one threshold may be necessary. However, because of the threat of fraud by inventors, it is preferred that only patented inventions be allowed to circumvent any of the thresholds, though it is conceivable that an invention in any stage of the patenting process may be included in the present invention.

The following will describe one possible example of an implementation of the present invention, although any variations obvious to one of ordinary skill in the art are within the scope of the invention.

An investor may sign up with the website and may deposit a certain sum of money through the website (although he may wait until after finding an investment opportunity before depositing). He may deposit through any known method, such as credit card, bank wire or transfer, or online money sites, such as PayPal™, and may pay any fees associated with such deposit. He may then browse the website for an invention in which he would like to invest. A specific example will be given momentarily with reference to the drawings.

A fee or commission may be paid for reaching any of the thresholds, or for brokering or being the middleman in any of the transactions. For example, if the first threshold is $1000 and is reached by an invention, a $50 handling fee or other commission may be paid to the company simply for its services in providing a medium for investors and inventors to meet, independently of any specific services performed by the company. In other words, a 5% or 10% commission may be taken from the revenue raised after an invention meets any of the thresholds, and then administrative, legal, and other costs may be paid from the remainder. In that sense, the investor would be paying a 5% or 10% commission to the company for brokering or managing the transaction between the inventor and investor. The company may alternatively or in addition charge labor, administrative, or handling fees for communicating with the inventor and preparing and having the inventor sign a contract, preparing a fuller description of the invention for search purposes, filing a provisional patent application, etc.

The company may charge other fees, such as a fee for printing a copy of a share certificate for an investor upon request, or a per-check fee paid out of dividends or share profits in the case of a successful patented invention. However, these fees are paid out of the investor's profits or by the investor requesting non-required services. In other words, the only fees that the investor may pay up front are a commission or administrative fee when an invention reaches one of its thresholds. If an invention doesn't meet one of its thresholds, the investors into that phase may be fully refunded (or simply never be charged). Alternatively or in addition, the investors may pay a membership fee, a transaction fee per purchase, and so forth. For example, to entice investors to buy more shares of an invention, the company may charge a small transaction fee (such as $1.95 per transaction), so that an investor who is contemplating purchasing two shares of an invention at $15 each purchases them at the same time to pay a single transaction fee, instead of buying them at different times. However, at its simplest, investors need not pay any fees or commissions at all to the company (although could still lose money by making poor investments), although it is preferable that they would pay some fees in the form of various commissions, such as when an invention reaches a threshold. Further, the company may charge various administrative or other fees, such as a $4.95 check fee for issuing dividends or royalties. If an investor owns a very small share in an invention that has produced only a small profit, such that the investor's share is a mere $3.00, then it is not worth the company's resources to distribute such a royalty. This amount may simply sit in the investor's account until she has accumulated enough that she is willing to pay the check fee to withdraw. The fee may instead be a withdrawal fee, and may depend on the means of withdrawal. For example, an electronic check to a bank or transfer to an online depository institution may be free or very inexpensive, in which case the company may charge little or no fee for the withdrawal.

The benefit to the investor is that he, for the first time ever, can invest small quantities of money directly in inventions. For $10, for example, he may purchase a 0.1% share in an actual invention. If that invention reaches the first threshold, and a prior art search is performed, and if the invention reaches the second threshold, and a patent application is filed, and a patent ultimately issues, then he will own a 0.1% share in a valuable invention. The invention is likely valuable because, necessarily, by the invention reaching the second (or final, if more than two thresholds) threshold, the invention has been invested in by many other people and lots of other money. In other words, because other investors are “putting their money where their mouth is,” he is assured that other people also find the invention valuable. While this is no guarantee of success, of course, it certainly is a good indicator, especially if the invention makes it to the final phase of patent application drafting and submission. If the invention turns out producing a royalty stream of $20 million, for example (not an unlikely profit on a strong patent on a popular and valuable invention), his 0.1% share, purchased at $10, would be worth $20,000. Assume that 100 shares of 0.1% are sold in a Dutch auction to 100 investors for $10 each (the price could be higher if more than 100 investors bid). A single investor is assured to not lose anything if not all shares are auctioned (assuming these are the rules of the company), which implies that in the present example, the investor is guaranteed of investing $10 only if at least 99 other people agree that the invention is valuable. Of course, an investor could buy more than one share, but in any event, the purchaser of a single share in this example is guaranteed to be incapable of losing money unless at least 99 other shares are bid for, a strong indicator of value in the invention. If the invention does not meet the first threshold, the investor loses nothing (assuming no other administrative costs or commissions), and if the invention does meet the first threshold, the investor is assured that other investors agree that the invention is valuable.

The same is true, of course, for the next phase, in which the investor has a prior art search report at his disposal, and the invention has been honed and inspected more thoroughly. Of course, this fact may be reflected in the price-per-share (either the price will be higher or the share size will be smaller or both), but again the investor is guaranteed to not lose money unless many other investors agree with him as to the value of the invention, thus causing the invention to reach the second threshold, and providing a strong indication as to the value of the invention. For example, if 1000 shares of 0.3% are auctioned in order to reach the second threshold, and the auction is successful, then the invention is now supported by over $11,000 (assuming the first threshold is $1000 and the second is $10,000) and up to 1,100 investors.

Not only does each investor get the guarantee of a “group consensus” (or at least money consensus) before his investment is placed at risk, but lie also gets the benefit of a larger number of people knowing about and spreading the word about the invention. If 1,100 (to use the example from above) people are talking and spreading the word about an invention they found interesting, useful, or valuable enough to invest money in, then there is a very good chance that the excitement generated from word-of-mouth alone could be sufficient to generate a grassroots market for the invention. In other words, the mere quantity of investors in an invention could cause the invention to be successful. Those 1,100 investors are not just detached investors—they are also consumers who know and influence many other consumers.

With use of the present invention, the investor finally gets the pleasure of investing in the rawest American dream: the invention. Not just investment in a company, which might own thousands of patents but rather the bare invention. He gets the pleasure of being one of the first to “discover” a really valuable invention and in having an actual stake in it. When he sees the invention being sold at his local mall, he can tell his friends that he owns a share in that invention, that it is partially his because he had the foresight and brilliance to identify the invention's value. In other words, the investor gets to invest in real inventions of his choice. His investment could be less than the price of dinner, yet it could yield him significant profits if the invention proves successful. He can own a stake in the American dream without much at stake, and his investment isn't really even at risk until enough investors band together with him for the invention to reach the threshold. In other words, he makes the investment exactly when many other talkative, consuming members of the public agree to make the same investment.

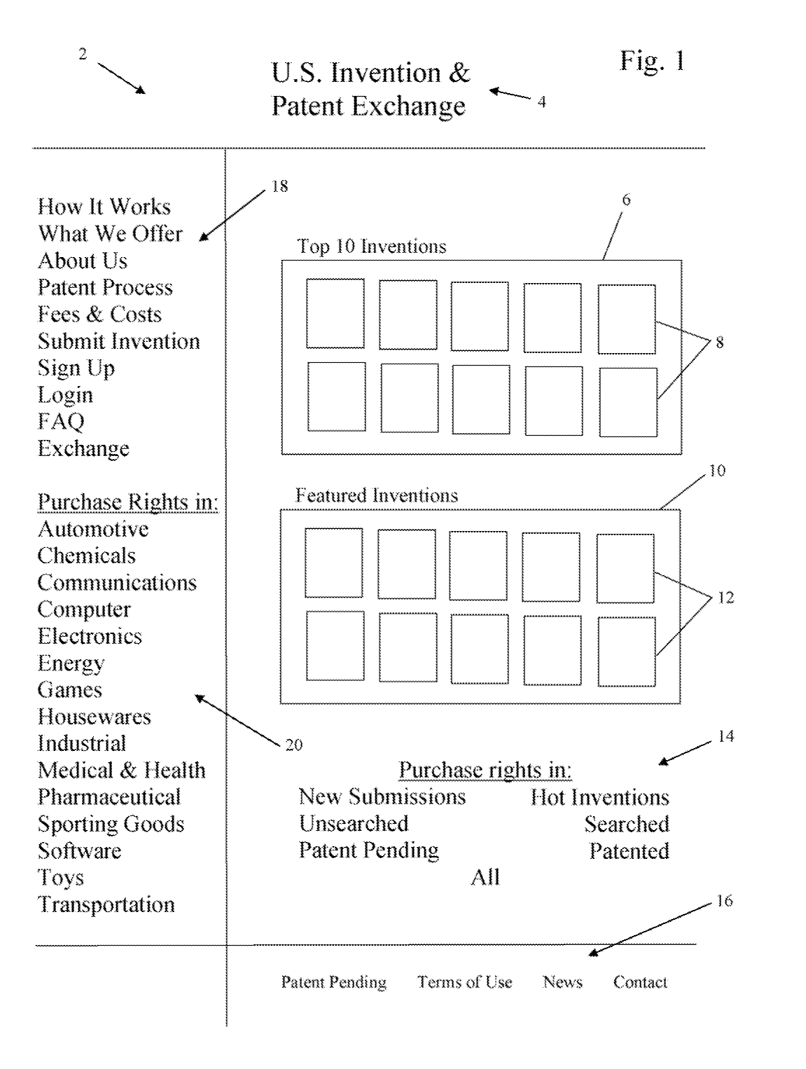

The following describes one possible embodiment of the current invention in the format of a website. Referring now to FIG. 1, a first or home webpage 2 of a website includes a title 4, a Top Ten box 6 showing the ten most popular inventions 8 for sale (any one of which may be selected or “clicked” to obtain more information), a Featured Inventions box 10 showing several inventions 12 (any one of which may be clicked to obtain more information) that are being featured by the website (such as because the inventor paid a fee to show his invention on the home webpage 2, because the invention is particularly unique or interesting, etc.), and a first Purchase Rights section 14 allowing a user to browse inventions for sale (i.e., invention shares for sale) according to desired criteria, such as New Submissions (inventions submitted to the website within a predetermined period of time), Hot Inventions (inventions selected for display due to popularity, share price, or any other aspect, which may or may not be similar to the aspects of the Top Ten box 6, described later), Unsearched (inventions that have not yet been professionally searched or have not reached the corresponding threshold), Searched (inventions that have been professionally searched or have reached the corresponding threshold), patent Pending (inventions for which patent applications have been drafted and/or submitted or that have reached the corresponding threshold), patented (inventions that have been patented), and All (to view all inventions for sale). Other criteria could be used, such as “First Action” for those inventions whose patent applications have first office actions from the Patent Office, or “Provisional” for those inventions for which a provisional patent application has been filed, or any other criteria representing different stages in the process of taking an invention from conception to profit.

The Top Ten box 6 could, of course, include a different number of inventions, and could show inventions that were of special interest because of one or more of these aspects: popularity (in terms of number of stars (explained later), number of shareholders, number of shares sold, etc.), share price, newness on the website, revenue raised, total share size sold, and so forth.

The home webpage 2 may also include a first link section 18 including links to useful webpages on the website, including How It Works (describing how the company's system, method, and/or website work, which may be tailored to inventors, investors, or both), What We Offer (describing the kinds of services offered by the company and the website), About Us (describing the company, the people involved, expertise, etc.), patent Process (describing the process of obtaining a patent on an invention), Fees & Costs (describing fees and costs borne by inventors, investors, and other users of the website), Submit Invention (taking the user to the webpage that allows an inventor to submit an invention disclosure to the website for selling the invention), Sign Up and Login (webpages dealing with user accounts, as understood by one of ordinary skill in the art), FAQ (providing answers to frequently asked questions), Exchange (taking the user to an online secondary market or exchange where he can buy or sell shares of inventions that are owned by persons other than the inventor), or any other webpage that would enable users to more efficiently and effectively understand and utilize the current invention.

The exchange allows investors who currently own shares in inventions to sell these shares to third parties, much like a stock market. For example, investors could post a description of the shares they own (e.g., 5 shares of Invention #157645 entitled “Pressurizer for a Rocket Engine,” whereby a fuller description of the invention may be viewed by clicking a link associated with the listing) and a suggested or asking price, or may auction these shares, or may simply ask for bids or offers, and third parties may then make offers, purchase shares at an asking or agreed price, make inquiries, etc. The prior art is full of examples of efficient exchanges and marketplaces, such as eBay™, the New York Stock Exchange, the American Stock Exchange, etc., that allow buyers and sellers to meet and exchange goods and services, and the present invention includes in its scope all exchanges and methods known in the art for transferring goods and services. In one aspect, shares of an invention may only be available for exchange in the secondary marketplace after the final threshold has been reached, while in another may be available for exchange before the final threshold has been reached. In one aspect, the inventor may (or may not) sell some of the shares in his invention (while retaining the required share size) through the secondary exchange, or may sell them through the company's website (i.e., the “Exchange” link versus the “patent Pending” or “patented” link).

The company may charge a transaction fee, such as a flat $4.95 fee or a percent commission or other hybrid fee, for brokering and registering each exchange or transaction. An advantage to including an exchange in the present invention is that it further encourages investors to invest if they believe that there is the possibility of liquidating their invention assets if desired.

The home webpage 2 may also include a second Purchase Rights section 20, allowing a user to browse inventions according to invention categories such as automotive, chemicals, communications, computer, electronics, energy, games, housewares, industrial, medical & health, pharmaceutical, sporting goods, software, toys, and transportation. Of course, other categories are within the scope of the invention, such as an “other” category, a “wild and wacky” category, or other invention categories. When a user clicks on one of these categories, it takes him to a new webpage showing inventions within that category.

The home webpage 2 may also include a second link section 16 including links to other useful webpages on the website, including patent Pending (describing the patent-pending nature of the method and system utilized by the website), Terms of Use (describing an agreement made between the company and a user of the website), News (including press releases or other relevant news regarding the company, business, inventions, inventors, investors, etc.), and a Contact webpage.

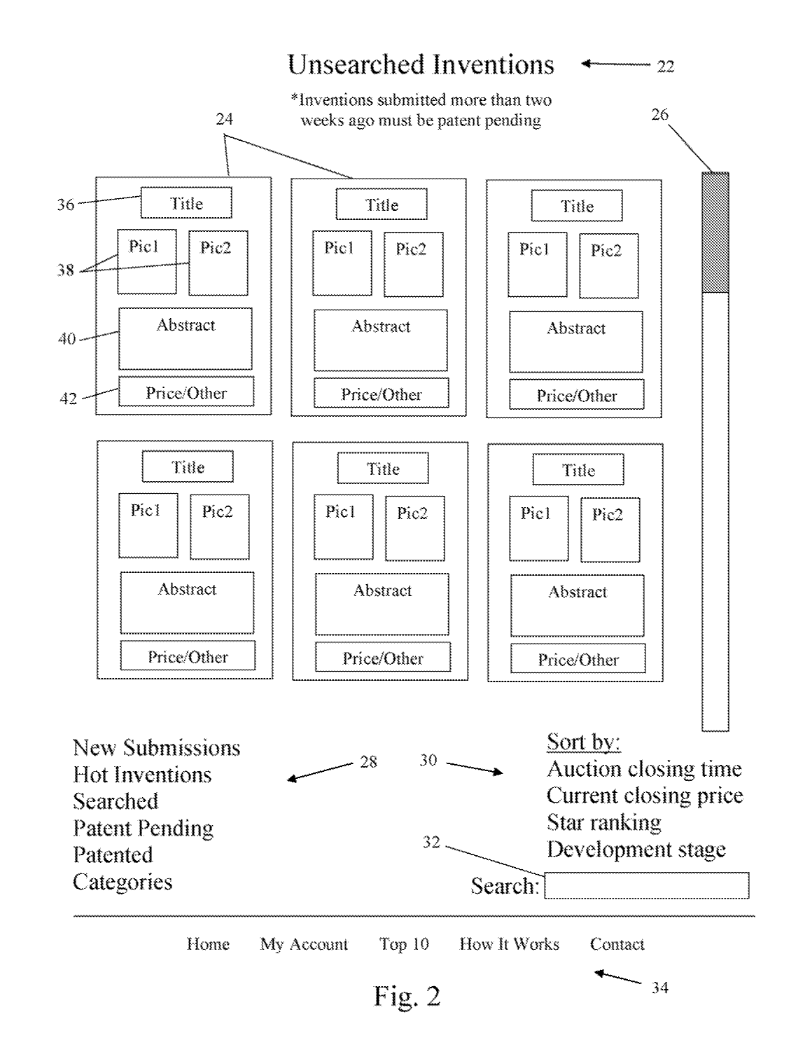

When the user selects or clicks on any of the criteria in the first Purchase Rights section 14, she is taken to a new webpage on the website showing inventions corresponding to that criterion. For example, if she selects Unsearched, she is taken to the webpage shown in FIG. 2, having Title 22 of “Unsearched Inventions.” The webpage shows a list of invention boxes 24 each containing descriptions of inventions fitting the named criterion or category (in the present example, unsearched inventions), including a title 36, pictures or drawings 38 (two are shown by fewer or more may be included), abstract 40 (which may be a brief description of the invention), and price/other 42 (which may indicate a current price, bid, clearing price, sales rank, number of shares sold, popularity, number of stars, auction time remaining, or any other pertinent information). The webpage may also be designed to list inventions fitting the named criterion by fewer variables (e.g., just the names of fitting inventions) or more variables (e.g., all pertinent information related to fitting inventions listed).

In the case of unsearched inventions, the company may require that a first or second threshold is rcached within a predetermined period of lime (such as one or two weeks) in order to protect the inventor's date of conception or reduction to practice by diligently submitting at least a provisional patent application. Inventions for which provisional patent applications have been submitted may, at the company's discretion, remain on the website for sale for a much longer period of time (although not exceeding a year after the provisional has been filed, since it expires after a year) to give the invention time to reach the next threshold and proceed toward a patent.

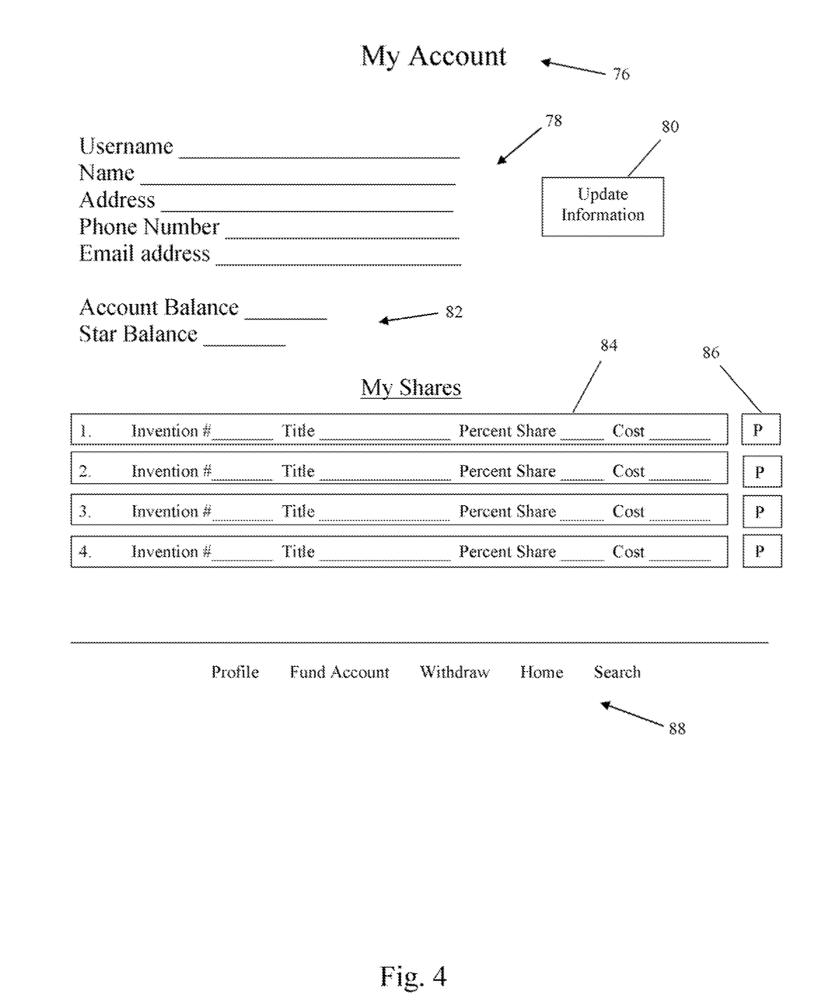

The webpage may include a scroll bar 26 allowing a user to scroll down and browse among invention boxes that, due to quantity, will not otherwise fit on the user's computer screen. The webpage may include a purchase rights section 28 that allows a user to browse inventions according to various criteria or categories, such as New Submission, Hot Inventions, Searched, patent Pending, patented, or Categories (or a list of specific categories), but it may leave out Unsearched because the user is already viewing unsearched inventions. The webpage may also include a Sort section 30 that allows the user, by clicking on the appropriate phrase, to sort the listed inventions according to one or more of Auction closing time (e.g., soonest closing time to most distant closing time), Current closing price (e.g., ascending or descending), Star ranking (e.g., number of stars received by users, ascending or descending), Development stage (e.g., newly submitted, all the way to patented, etc.), and any other sorting possibilities or options. A search box 32 may be included on this or any webpage (such as under the second Purchase Rights section 20 in FIG. 1) to allow a user to search for specific terms (according to a Boolean search, natural language, or other search methodology) in the inventions. If he types “rocket,” for example, the website may display for him all inventions that include the word “rocket” in the title, abstract, and/or description, and the website may rank these inventions according to where the word “rocket” was found, how many times the word “rocket” was used, or any other variable for sorting by relevance. The webpage may also include a link section 34 that may include links to the Home webpage, My Account (which may link to the webpage shown in FIG. 4), Top 10 (which may link to a webpage showing the top ten inventions, by whatever the company's criteria), How It Works (previously described), and Contact information. Of course, links to other useful webpages and information may be included in the link sections described herein, and are not limited to those shown.

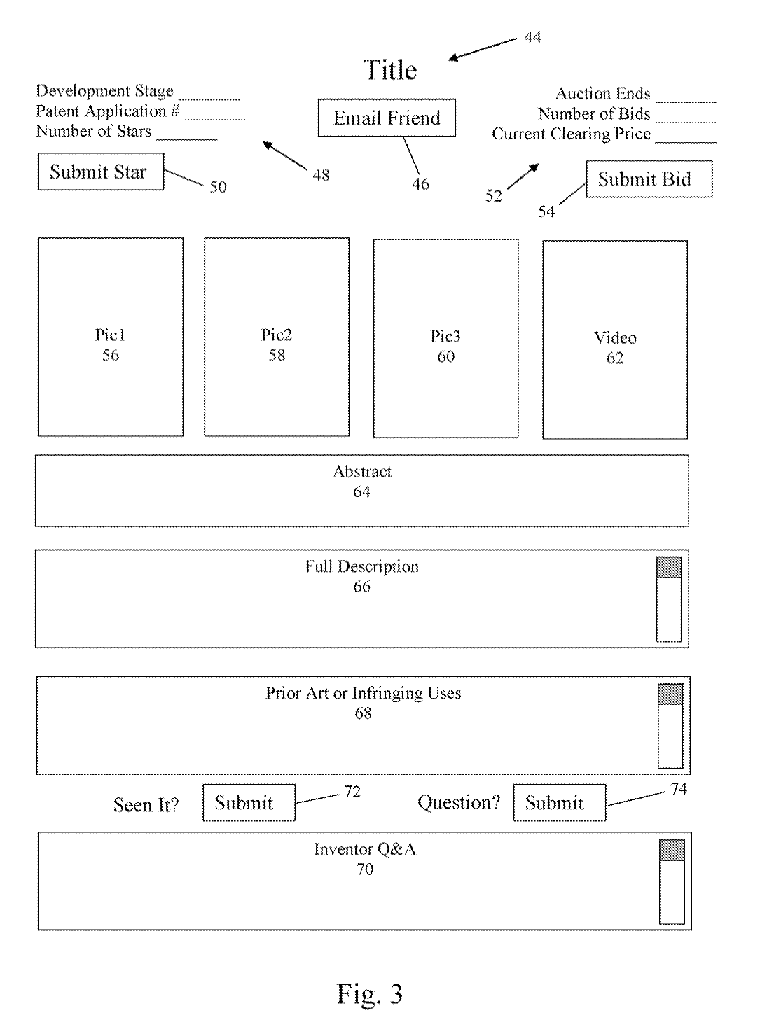

As a potential investor browses the inventions for sale shown in FIG. 2, he may become more curious about a particular invention, and may click on one of the invention boxes 24, leading him to the webpage shown in FIG. 3. FIG. 3 shows a webpage having a very full description of a particular invention, including Title 44 of the invention, an Email Friend 46 link (allowing the user to send information about the invention to another person via email), a first information section 48 including Developmental Stage (e.g., whether the invention has been professional searched, submitted in a provisional or nonprovisional patent application, patented, etc.), patent application No. (if applicable, which may include a link to the full patent application, the application publication (if applicable), and/or the prosecution information about the application available on the Patent Office website), Number of Stars, and other important information.

In one embodiment, users are given a certain number of “stars” (generally, preference indicators) that they may assign to their favorite inventions. Stars may be awarded only when users pay a fee through the website, or when they become investors, or when they deposit a certain amount of money to use for investing, and so forth, or may simply be available for free to anyone who signs up as a user. These stars may be given, received, and used in any manner known in the art, such as a currency, like used by the Hollywood Stock Exchange™, whereby users are given “Hollywood money” ($H) for free and may place $H in various movies, actors, and so forth. For example, users may be given a fixed or unlimited number of stars, may earn them in various ways, or may receive a certain number of stars per use or time, etc., and may “spend” them on inventions of their liking. Users may be limited to giving only one or up to a fixed number of stars per invention, or may give an unlimited number of stars per invention. The stars may act like a currency such that when users spend their stars on inventions they like, the “price” in stars of the invention increases, which indicates to investors that there is a greater public interest in the invention than other inventions. The stars may act like a rating system instead, such that users can give a rating, such as 4 out of 5 stars, to indicate their preference toward or against an invention. An advantage to such a preference indicator or false currency system is that members of the public who decide not to invest real money (or are incapable of doing so) can nevertheless help to indicate public (and hence consumer) opinion about an invention. An investor may be more willing to invest $10 or $100 (or more) in an invention that has a very high star rating because she knows that many people approve of or like the invention. If stars act as currency, a user may click on Submit Star 50 to “spend” one of his stars on an invention, and the Number of Stars will reflect this submission.

The webpage may include a second information section 52 that may include other important information, such as regarding the price and selling information. For example, if shares of the invention are being sold in a Dutch auction, then the section 52 may include information on when the Auction Ends, the Number of Bids (or possibly the total number of shares currently bid for), the number of shares still needed to be bid on to ensure meeting the next threshold (not shown), the Current Clearing Price, etc. An investor may bid on one or more shares of the invention by clicking on Submit Bid 54. Doing so will take him to another webpage (not shown) that allows him to enter a number of shares bid on, and a maximum bid price per share.

The webpage may include specific information about the invention, include first, second, and third (or more) pictures 56, 58, 60, video 62, abstract 64, full description 66, prior art or infringing uses 68, and an inventor Q&A 70. Of course, the webpage may include more or fewer than three pictures, and these pictures may include diagrams, photographs, drawings, figures, flowcharts, or any other visual depiction or description of the invention. The webpage may also include any other media that would be helpful in introducing and describing the invention. The video 62 may be a video of the inventor speaking about the invention, showing the working of a prototype, and so forth. The abstract 64 may be a brief description about the invention, while the full description 66 may be a fuller, more comprehensive, and in-depth written description. These descriptions may, at first, be produced by the inventor during the invention submission process. After a provisional patent application or prior art search request description are produced, these may be added to or may replace the inventor's original descriptions. Each of the description boxes may include scroll bars to allow an investor to read the entire entry, and the webpage may inself include a scroll bar (not shown) if the information shown is too much to fit on the user's computer monitor.

Prior Art or Infringing Uses 68 preferably contains information on inventions related to the described invention that have been sold, publicly used, published, or patented, and the date (if known) of such occurrences. Whether another invention is prior art, an infringing use, or neither depends on many factors, such as the other invention's date of conception, reduction to practice, date of selling, public use, publication, or patent, as well as the described invention's date of submission to the website, conception, reduction to practice, development stage of the invention, and so forth. The company could, of course, obtain a legal opinion regarding information and inventions cited in Prior Art or Infringing Uses 68. However, in order to remain as hands-off as possible, the information may simply be published, allowing the public and free market to make the determination (with their investment money) as to whether a related invention is deal-breaking prior art or a wallet-fattening potential infringer. Published in this section 68 may be the professional prior art search report, and/or information submitted by the users of the website. Users may have the option of submitting information about one or more related inventions or products by clicking on the Seen It? Submit 72 button, in which case they will have the chance to submit information (such as a patent or patent application number, magazine or newspaper article reference, etc.) on a related invention that may be relevant to the patentability of the described invention or relevant to its profitability after patenting.

The company may restrict who may submit information about related inventions (e.g., non-users, users, users who pay a fee, investors who deposit funds, or any combination of these entities), and/or may restrict the kinds of information that may be submitted. For example, there could be real problems with allowing any person to submit unsubstantiated claims regarding prior art. “I saw that thing at the Indiana State Fair back in 1947” is the sort of statement that, without further elaboration or evidence, is simply not valuable information, and could unfairly affect the value of shares of the invention. The company may require that users submit only specific kinds of easily verifiable information, such as patent or patent application numbers, magazine and newspaper article references, and so forth, so as to not unfairly prejudice the value of an invention. Of course, proponents of the free market might assert that information is valuable, no matter the quantity or source, and that investors will properly wade through the bad information and digest the good, in which case the company may allow more information to be submitted than that which is easily verifiable. Nevertheless, the company may provide on the website a template for submitting information regarding related inventions, which may or may not restrict the kind or quantity of information given. The company may provide checks-and-balances by allowing other users or the inventor to comment on information submitted in section 68, and/or may allow users to request the company to remove particular kinds of information if they are clearly not informative or useful.

The Inventor Q&A 70 may allow users to ask questions to the inventor and let the inventor reply. The questions may be posted before being answered by the inventor, or only after the inventor has replied. Alternatively, the questions and corresponding answers may be kept confidential by means of private email, and/or the company may route messages to the inventor from users without giving any personal information about the inventor. The company may allow users to request the company to remove particular kinds of information if they are clearly not informative or useful. The webpage shown in FIG. 3 (and any other webpage of the present website) may include any of the links discussed with respect to the other drawings.

Referring now to FIG. 4, a user may access her account by clicking a corresponding link on a different webpage, to reach My Account 76, including information section 78 that includes the user's username, name, address, phone number, email address, and other contact information, with an Update Information button 80 to allow the user to change any of this information. The webpage includes an account section 82 displaying the user's Account Balance (in money) and Star Balance, as well as a section displaying “My Shares,” which includes a listing of all inventions that she owns shares in. For example, a first listing 84 includes an invention number, title, percent share owned by that user, total cost paid by that user, and other important or relevant information regarding the user's ownership interest in that invention. By clicking on the listing 84, she can obtain other information about the invention, such as a webpage similar to that shown in FIG. 3 for the named invention. By clicking P (short for Purchase Share Certificate) 86, she can request a certificate indicating her ownership interest in the corresponding invention. The company may charge a processing and handling fee, such as $9.95 for sending a personalized share certificate to the user. The My Account page may also include any other relevant information to a user's account, such as recent and/or saved searches,

Further, where the inventor is the user, alternatively or in addition to the features discussed with respect to a user who is an investor, the My Account page may include links to and/or information about the inventor's submitted inventions, such as the status of inventions (e.g., which thresholds have been reached, current clearing price for inventions currently being auctioned, etc.), any profits collected by inventions, his share in his inventions, options to sell further shares in his inventions (but not to exceed the size allowed, requiring the inventor to maintain a predetermined interest in his inventions), the amount of money in his account, options to email friends and other people links to his inventions for further investment, and so forth.

The webpage may also include a link section 88 that includes Profile (a further description of the user's information, including bank account or credit card information, profit information, password, and other information important to the transactions described herein), Fund Account (linking to a webpage that allows a user to deposit money into his account with which to purchase shares in inventions), Withdraw (linking to a webpage that allows a user to withdraw money from his account back to his bank account or credit card or other financial institution), Home (back to the home page), Search (allowing a user to search the website or inventions for words or phrases), and so forth. In one aspect, a user can fund his account using a variety of sources, such as banks, credit cards, online providers like PayPal™, and others, and may pass transaction fees on to the user. For example, to fund his account with $100 using a credit card, the credit card may charge the company $5—thus the website may charge the user $105 to make the $100 deposit. This money can then be used by the user for purchasing or bidding on shares of one or more inventions.

In one embodiment, the present invention is implemented largely through use of a website, and publications occur on the website. The website of the company may be set up to be largely hands-off, allowing inventors to submit inventions and investors to bid on inventions with little to no human intervention. Of course, once thresholds are reached, human intervention may be required, but the company may be compensated for such services in the form of user or administrative fees.

Of course, the website may include many more pages than shown or described, and may be organized entirely differently and may include different or additional content than that shown. The drawings are simply to describe an example of one possible embodiment.

One problem with valuation of inventions is not just in determining their value, but that their value varies greatly. For example, one invention that is “worth” (in the sense that it ultimately produces in royalties) $20,000 is just as worthy of the cost of obtaining a patent as a second invention that is worth $20 million, in that their values both exceed the cost of obtaining the requisite patents. Nevertheless, a 0.1% share in the first invention is only worth $20, while an equal share in the second is worth $20,000. While these values are difficult to determine before a patent issues and royalties are actually paid, the public acting within a free market is generally a good predictor of such values. However, even if the market actually determines the value of a 0.1% share in an invention at $20,000, requiring investors to invest in an entire 0.1% share will significantly reduce the number of willing and able investors, and thus will artificially depress the price. Thus, in one embodiment, share prices are maintained in a predetermined range, such as between $10 and $100 each, or $1 and $10 each, or $5 and $50, or any range including any of these values, thus ensuring that members of the general public will be capable of purchasing shares if they desire.

To allow share prices to remain within a predetermined range, share sizes can automatically decrease to accommodate the rising prices. For example, if a user submits a maximum bid of $500 for one share of 0.1%, then when the price per share (during an auction) reaches $100, it may automatically drop to $10, splitting the shares tenfold, so that the price becomes $10 per 0.01% share, and the user's bid turns into a bid for 10 shares of 0.01% at $50 per share. Then, other investors can continue to bid for 0.01% shares, which now cost less than $100 per share.

Another possibility within the scope of the present invention is to allow a user to bid a total price-per-percent (or price-per-portion) that she is willing to pay, and then to specify how much she would like to pay. To use the above example, assume that a user values a 0.1% share of an invention at $500 (perhaps because she expects that the value of the invention is around $500,000), but is not willing or able to actually invest $500. She may then state that she wants to invest $100 in that invention. (The website may calculate for her what size share in the invention she will purchase if she successfully purchases at her maximum bid, which in this case would be 0.02%.) If the auction is successful, and the clearing price is $200 per 0.1% share, then she purchases 0.1%*($100)/($200)=0.05% share. In other words, whether or not she is a winning bidder is determined by her offered price-per-share or price-per-percent, even if she is not able or willing to pay for a full share or percent. She then purchases $100 in the invention, whose clearing price was $200 per 0.1% share. In the process of bidding, she might be told via the website, “If the auction closes at the current clearing price, you would own _x_% of the royalty rights to the invention, and if the auction closes at your maximum bid, you would own _y_% of the royalty rights to the invention.” The website might also indicate, “If the invention yields $_A_, then your share would yield $_B_,” where A could be hypothetical values such as multiples of 10, beginning with $100,000 and ending with $100 million, and where B is gotten by multiplying A by either the share x or y or both.

One possible way of implementing the above algorithm is to, after the successful auction is complete, order the bidders according to price-per-percent bid, then to find the clearing price among all the bids such that the total share size purchased by those who bid higher is just less than the total size that had been auctioned (e.g., 10% or 20%), with the small residual being purchased by the person whose bid set the clearing price.

Another possibility is to allow users to specify the size share they will to bid on. For example, a user may be given the option of bidding on various share sizes, such as 1%, 0.1%, 0.01%, 0.001%, etc., and the current clearing price of each of these sizes may be shown. For example, assume that the current clearing price of a 0.1% share in an invention is $2025. The user may then be given an option of bidding on a 0.1% share (by bidding higher than the current clearing price of $2025), a 0.01% share (by bidding higher than the current clearing price of $202.50), a 0.001% share (by bidding higher than the current clearing price of $20.25), etc. The clearing prices of the differing share sizes may be calculated in any way currently known in the art. One possible way of implementing this algorithm is to, after the successful auction is complete, order the bidders according to a normalized price-per-share bid, and whoever were the highest bidders on the total size that had been auctioned (e.g., 10% or 20%) win their portions, with the clearing price determined by (and the residual portion going to) the bid whereby lower bids failed.

Further, there may be a commission or other fee involved in dividing up 0.1% shares into smaller units. In the case of auctions, where two users submit the same winning bid but there are not enough shares to satisfy them both, the earlier bidder may get preference. Further, for each share size a user can bid on, the website may provide a table or chart that indicates, e.g., “If the invention ultimately yields $_A_in royalties, this share would yield $_B_.” The A figure could range, e.g., in multiples of 10, from $100,000 to $100 million, while the B figure might be the A figure multiplied by the corresponding share size. For example, for the above-mentioned share size of 0.01% whose clearing price is $202.50, immediately below may be a table that indicates that such a share might be worth $10 for a $100,000 invention yield, $100 for a $1 million invention yield, and so forth. Thus, an investor may easily and quickly determine his maximum bid based at least in part on his estimate of the value or ultimate yield of the invention.

Another possible method of pricing shares, instead of by auction, is to fix the price or cause the price to increase, such as linearly or exponentially. For example, the first 0.1% share of an invention may be priced at, e.g., $10, corresponding to an invention expectation of $10,000 (which is barely enough to make the invention a viable candidate for patenting). The second share might be some factor greater than the first share, such as 5% or 10% or 15%. The price might continue to rise exponentially for subsequent shares until shares stop selling for a predetermined lag time, in which case the price may be fixed at that final price. Alternatively, prices may increase linearly. Alternatively, prices may drop as a function of time, such as exponentially. For example, for each hour in which a share is not sold, prices decrease by a certain predetermined factor, or the price just drops continuously and exponentially with time, to allow prices to find a proper level at which the market is willing to buy shares. One way to determine an exponential growth rate is to determine a lowest allowable (or starting) price per share, such as $10 per 0.1% share, and a highest realistic price, such as $50,000 (such as for a patent worth $50 million), and to determine how many shares should be sold (such as 400 shares of 0.1% each), and then to solve to determine the exponential growth rate that will cause the first share sold to be $10 and the 400^{th} share sold to be $50 million. What is and is not realistic as a highest price is, of course, subject to debate.

A problem with such an approach is that the first shares sold will necessarily be sold for less than market value, since it is the growth that helps to find the market value. In other words, because investors would keep investing while the price is lower than the market value and stop investing when the price reaches or exceeds the market value, the very nature of the progression in helping to find the market value assures that a substantial number of shares are sold at below market value. Further, it is a very inefficient method of finding market value because, while market value is determined by many people interacting in a free market, in this approach individual people unilaterally change (increase) the price by buying shares. Buyers representing statistical outliers can push this price up far beyond the true market value. Because this method is inefficient at finding market value, it is likely that too few shares will be sold (perhaps not even enough to reach the final threshold), or else all of the shares will be sold for an excessively low price. Both results are economically inefficient. Nevertheless, the present invention does include embodiments in which share prices are determined by a predetermined algorithm that may depend on the number of buyers, number of shares sold, total size of shares sold, time (e.g., time elapsed since the last sale), desired revenue and thresholds, category or field of the invention, qualitative evaluations of the invention, and other factors.

The present invention may include publishing (e.g., on a website) of a prior art search report, the provisional patent application, the nonprovisional patent application, any office actions or correspondence to/from the Patent Office, the issued patent, and/or any other information that may be valuable or useful to gaining the confidence of potential investors.

Regarding full or partial refunds by offering to purchase back shares (for full or partial price) from investors, in one aspect the company may offer to purchase back shares after each of several big events, such as the publication of any of the above information. The protocol for refunding may be as previously discussed, such as refunding only from the excess after meeting relevant thresholds, or refunding prorated amounts from these excesses. Allowing investors to sell back their shares at even a reduced price after obtaining further information (such as a final office action rejecting all claims) may give investors more confidence and make them more likely to invest in the first place. Investors requesting refunds may be informed of exactly how much will be refunded before they decide to accept the refund (and lose their shares in the invention). Ultimately, these shares may revert back to the inventor.

Further, if a threshold is not met, such as after an auction, in one aspect another auction may be repeated if a certain minimum percentage of shares were bid on. For example, assume this minimum percentage is 50%. Thus, if in attempting to meet the first threshold 100 shares of 0.1% at a starting bid of $10 were needed to sell, but only 68 shares were bid on, then the auction would fail but 68 exceeds 50% of the 100 needed to sell, so the auction may be repeated. However, if only 41 shares were bid on, then the auction is not repeated. This may apply to meeting any of the thresholds. However, the minimum percentage may be lower, such as 10% or 20% or 30%, for meeting the second or third threshold, after a provisional patent application is filed, as there is less worry about losing rights to the invention with the passing of time. Nevertheless, an invention that receives very little bidding, if any (i.e., those that fall below the minimum percentage) may be removed from the website simply due to concerns about cluttering up the website with inventions that are not valuable.

In one aspect of the present invention, the inventor assigns his invention to the company, in exchange for the power, via the company's website and/or other services, to raise sufficient revenue to patent the invention, and in exchange for the contractual right to royalties from the invention. For example, assume that 10% of the royalty rights to the invention are retained by the company, 60% are retained by the inventor, and 30% were sold to investors to raise revenue to reach the third threshold (corresponding to the patent threshold). The invention is subsequently patented, and a manufacturer licenses the patent from the company, producing (according to the terms of the contract) a royalty stream of, say, $1 million in the first year. That royalty is then divided according to the respective shares owned: $600,000 to the inventor, $100,000 to the company, and $300,000 divided among the shareholders commensurate with their respective share ownership. For example, a shareholder who owns a 1% share would then receive $10,000, and a shareholder who owns a 1.5% share would receive $15,000, and so forth.

In one aspect, the company owns each invention and patent for the purpose of maintaining a controlling interest, with a contractual obligation to distribute profits or royalties according to share ownership. The inventor, upon listing the invention on the website, may be required to assign the invention to the company, but with rights of reversion if one or more of the thresholds are not reached. For example, if an invention reaches a search threshold, and is searched, but is incapable of reaching a nonprovisional patent threshold because, for example, the prior art discovered in the prior art search report is particularly good or close, then rights to the invention may then revert back to the inventor. Alternatively or in addition, investors who have already purchased shares in the invention to help it reach one of the thresholds may be allowed to retain that interest in the invention. However, there may not be any rights of reversion, except possibly if the invention has not reached any thresholds. For example, if an invention reaches the search threshold and a provisional patent application has already been filed, then the invention might be required to remain on the website for sale until the provisional application expires, in which case a patent is barred on the invention because it had already been published for over a year.

In one aspect most or all of the method may be performed automatically on a website. For example, soliciting of invention disclosures, publication of the invention disclosures, and selling shares of rights to the invention to raise revenue could all be performed on a website. Further, once a threshold has been established, the steps of determining if at least one of the revenue, number of shares sold, and total size of shares sold exceeds the first threshold, and causing a prior art search report or a patent application to be drafted on the invention, could be performed automatically by the website. For example, once the first threshold is reached (corresponding to a provisional application to be filed and the invention to be searched), the description of the invention could be automatically forwarded to a patent agent, patent attorney, and/or professional searcher, who then performs the necessary services. They may be automatically paid for their services, too, and the search report may be automatically published on the website. The same is true for the next threshold, whereby a nonprovisional patent application is drafted and submitted to the Patent Office. In other words, any or all of the steps described according to the present method may be performed automatically, such as by a website (i.e., via a computer running software).

One may cause a patent application or prior art search report to be drafted, for example, by sending the invention description (e.g., the one created by the inventor) to a patent agent/attorney or professional patent searcher and requesting that, respectively, a patent application or prior art search report be drafted. Alternatively or in addition, a user of the present method (such as a representative of the company) may cause these documents to be drafted by simply drafting them. These are merely examples and do not limit the ways in which one may cause a patent application or prior art search report to be drafted. One of ordinary skill in the art knows how to cause an event.

Profit may be collected on an invention by several means. First, profit may be collected even before a patent issues, such as by licensing a patent-pending invention and/or an invention whose patent application has been published. Profit after a patent issues may be obtained through many means, including licensing the invention to a user or seller, a court or mediation settlement in the case of infringement, or a court order or award or judgment in the case of infringement. The total profit simply includes the total paid by another for use or infringement of the patent, minus the costs necessary to obtain that money (e.g., litigation or attorney costs).

In one aspect, the patent application filed is published by the Patent Office at the normal, or preferably earliest, publication time. Because the invention and patent application may already be published on the website, and thus are exposed to the public early, the company, inventor, and investors should also benefit by “provisional” rights, which are royalty rights, available under certain conditions after a patent issues, that are retroactive to the time of publication by the Patent Office. The current fee for early publication (which usually takes place around three months after filing the early publication request) is $300.

The company may or may not perform additional services, such as litigation services. In one aspect, the company simply obtains and holds patents for inventors and investors, and waits for potential licensees to approach the company for licenses or for infringers to infringe the patents, in which case the company may then contract with other service providers (e.g., attorneys) to do the necessary work to extract royalties, damages, payments, etc. Alternatively or in addition, the company may have its own in-house legal team to perform some or all of these services. These services may be paid for by contingency fees (e.g., the attorney accepts the risk of performing the work for no cost up front, but charges a large fee, such as ⅓ of the settlement or court award if the suit is successful), the royalty or revenue stream from the patent at issue (or money raised in excess of the final threshold that has not been dispersed to the inventor or others), and/or a fund set aside by the company for such purposes, which may be paid into by any of the company's sources of money. Further, the company may guarantee responsibility only for legal or administrative expenses involved with prosecution of the patent application to patent, such as in appealing Patent Office decisions or in interference proceedings, but, once the patent is issued, may not guarantee any further action, or may depend only on outside counsel taking the case on a contingency basis, and so forth.

Preferably, the company is prepared to pay for legal actions in one or more cases, using a fund that has been paid into by at least one of the company's revenue sources, such as commissions. Often, a very valuable invention is finally rejected by the Patent Office, and if representatives of the company find the invention worth pursuing, it would be prudent to pay for the legal costs of appealing the Patent Office's decision. The same is true of interference proceedings for a valuable invention, wherein a second inventor asserts that he is the earlier inventor and thus the rightful owner of the resulting patent. The company should not give up on cases, particularly valuable cases, simply because of various legal roadblocks that may be overcome, and thus should have a fund available for such contingencies. Usually such issues don't arise with regard to issued patents, because usually the only patents that are ever litigated (with regard to infringement, validity, enforcement, etc.) are those that are relatively valuable, and thus such cases may be paid for via contingency fee arrangements with attorneys or pre-existing revenue streams from the patent.

The thresholds may be predetermined or may change according to various factors, including but not limited to: changing or rising attorney's fees and Patent Office fees, etc., complexity or field of the invention, development stage of the invention, patent prosecution problems or issues, and so forth. The thresholds may be automatically determined (e.g., a higher predetermined threshold for inventions in the chemical field versus in the mechanical field) or determined by a professional or representative/employee of the company.

In one aspect, investors are given the option of buying or bidding on shares of an invention in units of money (cost) or share size. For example, an investor may bid up to $100 for a 0.1% share in an invention, in which case, if he wins, he will have purchased 0.1% share at up to, but not exceeding, $100. Alternatively, he may be given the option of bidding $100 for “down to but not less” than 0.1% share, in which case, if he wins, he will have spent exactly $100 for a share that may be greater than, but is not less than, 0.1%.

In one embodiment, investors must invest a certain minimum per transaction, such as $10 or $20 or $50 or $100, to ensure that the company's registry is efficiently used and not wasted on investors spending only a couple of dollars. However, if all transactions are accompanied by a transaction fee (again, flat, percent, or hybrid), then perhaps no minimum investment is necessary, since transaction, registry, and other costs are borne by the investors.

In one embodiment, where the present invention is used to sell shares of patented inventions, the minimum bid for a share (such as a 0.1% share) may be predetermined by the company, may depend on the nature, field, or type of invention, may depend on a qualitative analysis of the patent (including considerations of expected market value, patent strength (e.g., claim breadth, prosecution history, etc.), competition, etc.), may be determined by the inventor, etc.

I claim:

1. A method of implementing an invention exchange, comprising:
a) soliciting an invention disclosure of an invention;
b) publishing the invention disclosure;
c) selling a plurality of shares of rights to the invention to raise revenue;
d) establishing a first threshold;
e) determining if at least one of the revenue, number of shares sold, and total size of shares sold exceeds the first threshold; and
f) based at least in part on the determining in step e), causing at least one of a prior art search report to be drafted on the invention and a patent application to be drafted on the invention.

2. The method as claimed in claim 1, wherein step f) comprises: based at least in part on the determining in step e), causing the prior art search report to be drafted, and wherein the method further comprises:
g) establishing a second threshold different than the first threshold;
h) determining if at least one of the revenue, number of shares sold, and total size of shares sold exceeds the second threshold; and
i) based at least in part on the determining in step h), causing the patent application to be drafted.

3. The method as claimed in claim 1, further comprising:
causing a patent to issue on the invention;
collecting profit on the patent; and
distributing the profit based at least in part on the plurality of shares sold.

4. The method as claimed in claim 1, wherein steps a)-c) are performed automatically on a website.

5. The method as claimed in claim 1, further comprising determining a price for at least one of the shares based at least in part on at least one of the number of shares sold and the total size of shares sold.

6. The method as claimed in claim 1, further comprising determining a price for at least one of the shares based at least in part on a time elapsed.

7. The method as claimed in claim 1, wherein step c) comprises selling the plurality of shares by auction.

8. The method as claimed in claim 7, further comprising:
receiving from a bidder a price-per-portion bid and a desired investment amount; and
determining a clearing price of the auction based at least in part on the price-per-portion bid and the desired investment amount.

9. The method as claimed in claim 7, further comprising causing share size to automatically decrease with increase in clearing price.

10. The method as claimed in claim 1, further comprising providing a secondary market through which shareholders may sell the shares to others.

11. The method as claimed in claim 1, further comprising providing an option for a user to publish prior art regarding the invention.

12. The method as claimed in claim 1, further comprising requiring an inventor of the invention to retain a predetermined interest in the invention.

13. The method as claimed in claim 1, further comprising:
publishing at least one of the prior art search report and the patent application; and
offering to purchase at least some of the shares sold in step c).

14. A method of implementing an invention exchange, comprising:
a) soliciting, via a website, invention disclosures of inventions;
b) publishing the invention disclosures via the website;
c) selling via the website a plurality of shares of rights to a first invention to raise revenue;
d) establishing a first threshold;
e) determining if at least one of the revenue, number of shares sold, and total size of shares sold exceeds the first threshold;
f) based at least in part on the determining in step e), causing a prior art search report to be drafted on the first invention;
g) establishing a second threshold different than the first threshold;
h) determining if at least one of the revenue, number of shares sold, and total size of shares sold exceeds the second threshold; and
i) based at least in part on the determining in step h), causing a patent application to be drafted on the first invention.

15. The method as claimed in claim 14, wherein step c) comprises selling the plurality of shares by auction.

16. The method as claimed in claim 14, further comprising:
publishing at least one of the prior art search report and the patent application; and
offering to purchase at least some of the shares sold in step c).

17. The method as claimed in claim 16, further comprising:
causing a patent to issue on the invention;
collecting profit on the patent; and
distributing the profit based at least in part on the plurality of shares sold.

18. The method as claimed in claim 14, further comprising:
providing users a preference indicator with which to express preference for an invention; and
publishing a preference indicator rating of the inventions based on preference indications by the users.
